(19) United States
(12) Patent Application Publication
(10) Pub. No.: US 2021/0374635 A1
(43) Pub. Date: Dec. 2, 2021

(54) SCALABLE ASSISTIVE DATA GENERATION AND DELIVERY

(71) Applicant: ZEBRA TECHNOLOGIES CORPORATION, Lincolnshire, IL (US)

(72) Inventors: Sergey Klyutsev, Buffalo Grove, IL (US); Kevin B. Mayginnes, Schaumburg, IL (US)

(21) Appl. No.: 16/887,059

(22) Filed: May 29, 2020

(51) Int. Cl. G06Q 10/06; G06N 20/00

(52) U.S. Cl. CPC G06Q 10/06311; G06N 20/00

(57) ABSTRACT

A method in a server of generating assistive data includes: receiving, at the server from a client device, a request for assistive data, the request including (i) client contextual data, and (ii) a type indicator corresponding to a first request type or a second request type; selecting between an automated response mechanism, when the type indicator corresponds to the first request type, and a manual response mechanism when the type indicator corresponds to the second request type; responsive to selecting the automated response mechanism, retrieving automated assistive data from a repository based on the client contextual data; and returning the automated assistive data to the client device.

### BACKGROUND

Workers in operations such as manufacturing, field services (e.g. equipment installation or repair) and the like may perform tasks that are at least partly dependent on skill and experience levels of the workers. In some cases, such workers may rely on the skill and/or experience of other users to complete tasks. Such other users may be referred to as experts. The number of expert users available to an organization, however, may be limited, and the availability of such experts to workers may be further restricted by physical location, time zones, and the like.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for generating and delivering assistive data.

FIG. 2A is a block diagram of certain internal hardware components of the server of FIG. 1.

FIG. 2B is a block diagram of certain internal hardware components of a client device of FIG. 1.

FIG. 3 is a flowchart of a method of obtaining assistive data at a client device of the system of FIG. 1.

FIG. 4 is a flowchart of a method of obtaining assistive data at the server of the system of FIG. 1.

FIG. 5 is a diagram illustrating example performances of blocks 305-330 of the method of FIG. 3, and blocks 405-420 of the method of FIG. 4.

FIG. 6 is a diagram illustrating an example performance of blocks 335-345 of the method of FIG. 3, and blocks 405, 425 and 430 of the method of FIG. 4.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a server of generating assistive data, the method comprising: receiving, at the server from a client device, a request for assistive data, the request including (i) client contextual data, and (ii) a type indicator corresponding to a first request type or a second request type; selecting between an automated response mechanism, when the type indicator corresponds to the first request type, and a manual response mechanism when the type indicator corresponds to the second request type; responsive to selecting the automated response mechanism, retrieving automated assistive data from a repository based on the client contextual data; and returning the automated assistive data to the client device.

Additional examples disclosed herein are directed to a server, comprising: a memory storing a repository of assistive data; a communications interface; and a processor configured to: receive, from a client device, a request for assistive data, the request including (i) client contextual data, and (ii) a type indicator corresponding to a first request type or a second request type; select between an automated response mechanism, when the type indicator corresponds to the first request type, and a manual response mechanism when the type indicator corresponds to the second request type; responsive to selection of the automated response mechanism, retrieve automated assistive data from the repository based on the client contextual data; and return the automated assistive data to the client device.

Further examples disclosed herein are directed to a system, comprising: a client computing device configured to transmit a request for assistive data; and a server, comprising: a memory storing a repository of assistive data; a communications interface; and a processor configured to: receive, from a client device, a request for assistive data, the request including (i) client contextual data, and (ii) a type indicator corresponding to a first request type or a second request type; select between an automated response mechanism, when the type indicator corresponds to the first request type, and a manual response mechanism when the type indicator corresponds to the second request type; responsive to selection of the automated response mechanism, retrieve automated assistive data from the repository based on the client contextual data; and return the automated assistive data to the client device.

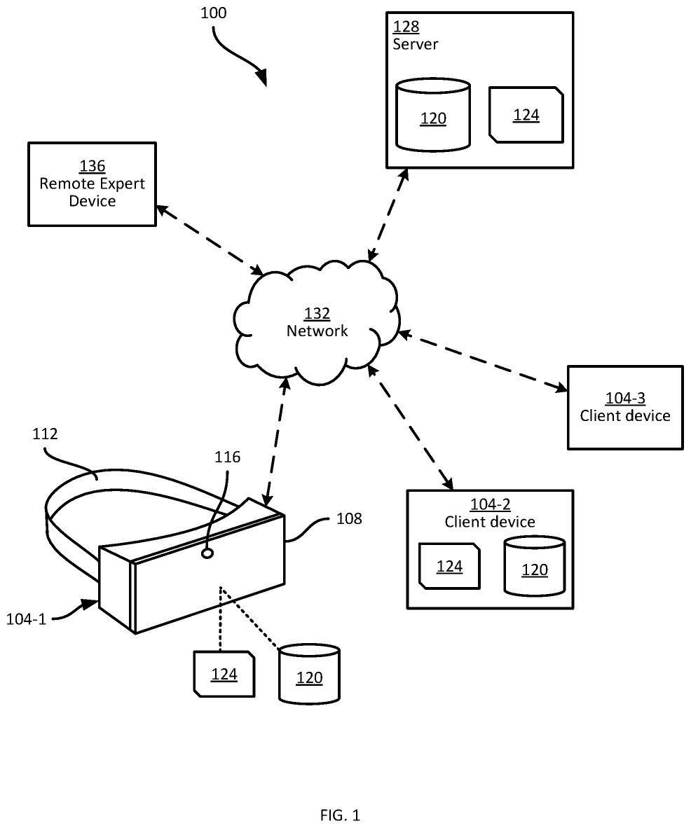

FIG. 1 shows a system 100 for scalable assistive data generation and delivery. The system 100 includes a plurality of client devices, of which three examples 104-1, 104-2 and 104-3 are shown. In other examples, the system 100 can include larger or smaller numbers of client devices 104.

The client devices 104 are mobile computing devices operated by, for example, workers in manufacturing facilities, premises where a wide variety of equipment or other facilities are installed, or the like. The operators of the client devices 104 may perform tasks such as the installation and/or repair of equipment that may rely at least in part on operator experience and skill. The client devices 104 may be used by the operators to, among other functions, obtain assistive data to complete tasks outside the operators' previous experience or skill levels. Assistive data can include images, text, audio instructions, or the like.

The client devices 104 can include any of a wide variety of mobile computing devices, such as smart phones, tablet computers, and the like. In the present example, the client devices 104 are head-mounted display devices, which may also be referred to as virtual reality (VR) headsets. The other client devices 104 may also be VR headsets, or may be other types of mobile computing devices.

The client device 104-1 is illustrated as such a device, including a housing 108 containing a display and other computing components, and a headband 112 or other fastener to mount the device 104-1 on an operator thereof in a hands-free manner. The client device 104-1 also includes a camera 116 and/or microphone used to capture video and/or audio of the surroundings of the device 104-1. Such information, which can also be referred to as client contextual data, may be presented to the operator of the device 104-1 to provide a digital augmented reality (AR) function.

The above-mentioned digital AR function can enable an operator of the device 104-1 to perceive their surroundings and also access (e.g. via AR overlays, audio played via speakers of the device 104-1, and the like) assistive data relating to a task being performed by the operator.

Some client devices 104 may be configured to generate such assistive data locally. For example, the client device 104-1 and the client device 104-2 each store a repository 120 of assistive data. The client devices 104-1 and 104-2 can be configured to process video and/or audio data captured by cameras and microphones thereof (e.g. the camera 116), as well as operator commands received via other input assemblies of the devices 104. The video and/or audio, and operator commands define contextual data for the devices 104-1 and 104-2. Such contextual data can also include location data defining a location of the device 104, task data defining a task currently being performed by an operator of the device 104, and the like.

Based on such processing, the client devices 104-1 and 104-2 may retrieve specific assistive data from the repository 120 that is relevant to the task being performed by the operator. Retrieval of assistive data from the repository 120 can be implemented via application of a classification model 124 to the client contextual data. For example, the model 124 can include parameters defining a neural network or any other suitable machine learning process configured to accept contextual data as input and retrieve certain assistive data from the repository 120 as output. The model 124 may, in other words, implement an assistive bot.

Certain client devices 104, such as the device 104-3, may not have sufficient computational resources to store the repository 120 and/or apply the model 124 to retrieve assistive data. To enable such devices 104 to nevertheless obtain and present assistive data to their operators, the system 100 also includes a server 128 connected with the devices 104 via a network 132 (e.g. any suitable combination of local and wide area networks).

The server 128 also stores the model 124 and repository 120. The server 128 is therefore enabled to receive contextual data from client devices 104 (such as the device 104-3) and provide assistive data from the repository 120 to the client devices 104 via the network 132. As will be discussed below in greater detail, the server 128 is also configured to handle requests from the client devices 104-1 and 104-2 (that is, client devices 104 with the capability to process the model 124 and present assistive data locally). In some cases, the model 124 may produce sub-optimal results, such as selecting marginally relevant assistive data from the repository 120 for presentation to the operator. The client devices 104 may enable the transmission of requests to the server 128 for additional assistive data in such cases.

To that end, the server 128 is also configured to communicate with a remote expert computing device 136 via the network 132. The device 136 can be implemented as any suitable computing device, such as a laptop computer, a desktop computer, and the like. The server 128 can route certain requests from client devices 104 to the device 136, where an expert operator can select or generate assistive data (which may not previously have existed in the repository 120). Such assistive data, which is selected manually rather than automatically as via application of the model 124, is returned from the device 136 to the server 128 for delivery to the requesting client device 104.

The server 128, in other words, provides assistive functionality to those client devices 104 that lack the model 124 and repository 120 in local form, and intermediate between client devices 104 and the expert device 136, e.g. in the event that application of the model 124 yields sub-optimal results. The intermediation performed by the server 128 also enables the server 128, as will be discussed below, to update the model 124 and/or the repository 120 (e.g. via retraining of the model 124), and to deploy an updated version of the model 124 and/or the repository 120 to the client devices 104 that are capable of local application of the model 124.

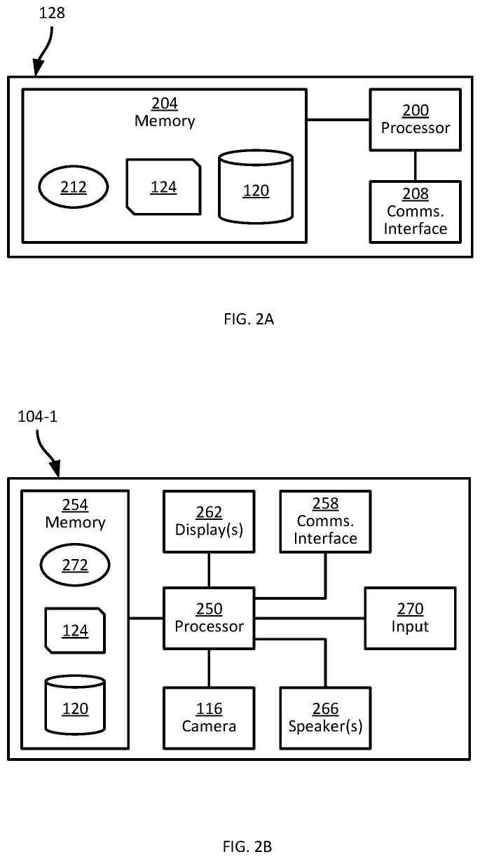

Turning to FIGS. 2A and 2B, certain internal components of the server 128 and the client device 104-1 are shown. With reference to FIG. 2A, the server 128 includes a processor 200, such as a central processing unit (CPU), graphics processing unit (GPU) or a combination thereof. The processor 200 is interconnected with a non-transitory computer readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 each comprise one or more integrated circuits. The server 128 can also include a communications interface 208 enabling the server 128 to exchange data with other computing devices via the network 132 (e.g. the client devices 104 and the remote expert device 136).

The memory 204 stores a plurality of computer-readable instructions, e.g. in the form of one or more applications. The applications stored in the memory 204 include, in the present example, an assistive data management application 212, also referred to herein simply as the application 212. The application 212 can be executed by the processor 200 to configure the processor 200 to perform various actions, including retrieving and sending assistive data from the repository 120 via application of the model 124, routing of requests from client devices 104 to the expert device 136, and updating of the model 124 and repository 120. The processor 200, or the server 128 more generally, are said to be configured to perform such actions, and it will be understood that they are so configured via execution of the application 212 by the processor 200. In other examples, the application 212 can be implemented as a set of related applications. In further examples, some or all of the functionality implemented via the instructions of the application 212 can instead be implemented in the form of specialized hardware components, such as field-programmable gate arrays (FPGAs) or application-specific integrated circuits (ASICs).

Turning to FIG. 2B, the client device 104-1 includes a processor 250, such as a central processing unit (CPU), graphics processing unit (GPU) or a combination thereof. The processor 250 is interconnected with a non-transitory computer readable storage medium, such as a memory 254. The processor 250 and the memory 254 each comprise one or more integrated circuits. The device 104-1 can also include a communications interface 258 enabling the device 104-1 to exchange data with other computing devices via the network 132 (e.g. the server 128).

The client device 104-1 also includes at least one display 262, and the above-mentioned camera 116. The client device 104-1 may also include additional output devices, such as at least one speaker 266. The client device 104-1 may further include an input assembly 270 as mentioned above. The input assembly 270 can include any suitable combinations of microphones, buttons, keypads, and the like.

The memory 254 stores a plurality of computer-readable instructions, e.g. in the form of one or more applications. The applications stored in the memory 254 include, in the present example, a task assistance application 272, also referred to herein simply as the application 272. The application 272 can be executed by the processor 250 to configure the processor 250 to perform various actions, including collecting contextual data such as audio and video via the camera 116 and input assembly 270, retrieving assistive data from the repository 120 for presentation via the display 262 and speaker 266, and transmitting requests to the server 128 under certain conditions. As noted in connection with the application 212, the application 272 can also be implemented as a plurality of distinct applications, and/or as dedicated hardware components such as FPGAs or ASICs.

As will be apparent to those skilled in the art, other client devices 104 can also include the components shown in FIG. 2B in connection with the client device 104-1. The components included in other client devices 104 need not be identical to those of the client device 104-1, however. For example, certain client devices 104 (e.g. the device 104-3) may include less capable processors 250, smaller memories 254, or the like.

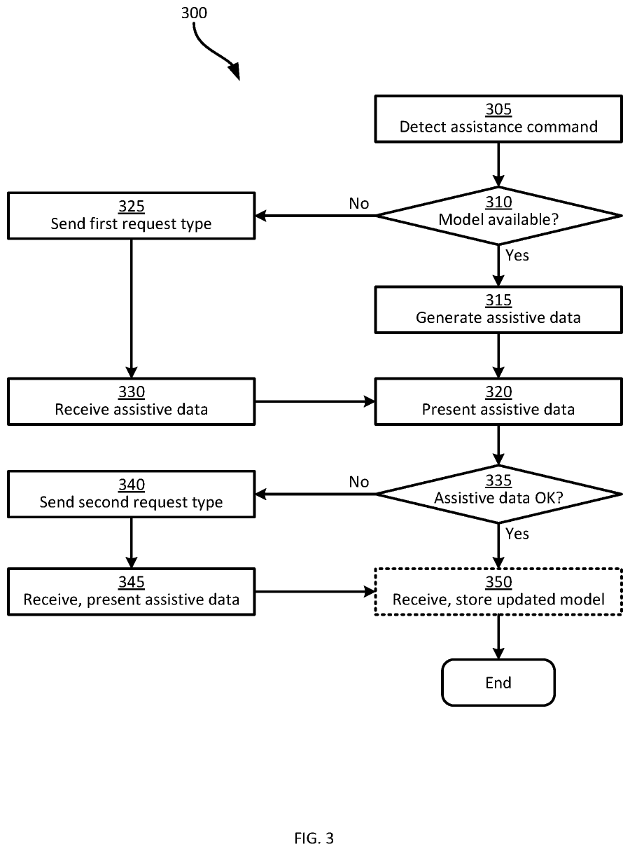

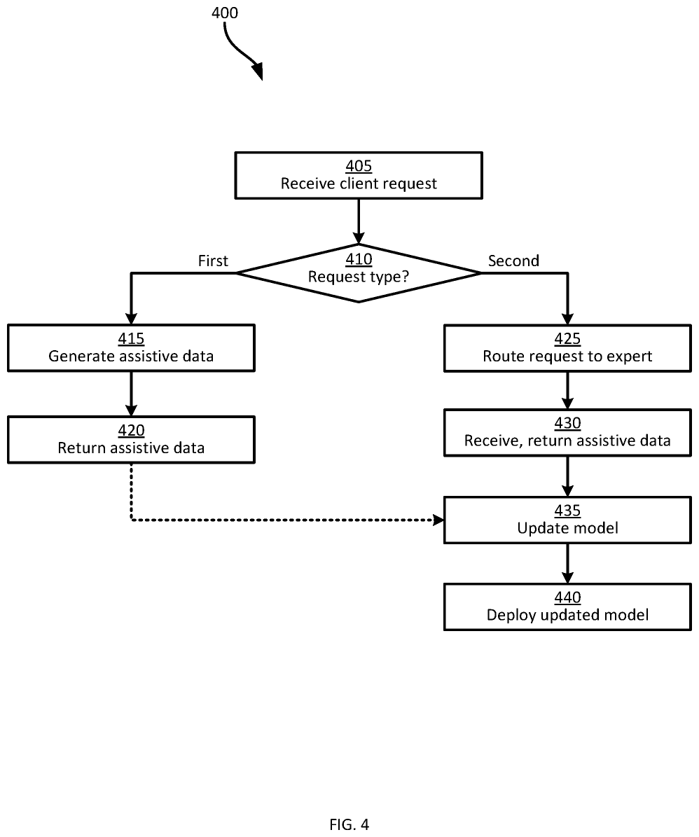

With reference to FIGS. 3 and 4, the functionality implemented within the system 100 will be discussed in greater detail. In particular, FIG. 3 illustrates a method 300 of obtaining assistive data, as performed by the client devices 104. FIG. 4, meanwhile, illustrates a method 400 of assistive data management at the server 128. As will be apparent in the discussion below, the performance of the method 300 at some or all of the client devices 104 is associated with the performance of the method 400 at the server 128 (e.g. multiple instances of the method 400, each corresponding to a performance of the method 300 at a client device 104).

Turning first to FIG. 3, performance of the method 300 begins at block 305. At block 305, a client device 104 detects an assistance command via the input assembly 270. For example, an operator of the client device 104 may issue an audible command, activate a button or the like to indicate that assistive data is desired for a task being performed by the operator. In response to the assistance command, the device 104 determines, at block 310, whether the model 124 is available locally.

That is, the device 104 determines whether the model 124 is stored in the memory 254. The determination at block 310 may be negative under various conditions. For example, the device 104-2 may make a negative determination at block 310 if the model 124 and/or repository 120 have not yet been deployed to the device 104-2, despite the fact that the device 104-2 has sufficient computational resources to use the model 124 locally. The device 104-3, on the other hand, may make a determination at block 310 because the device 104-3 has insufficient computational resources to use the model 124.

When the determination at block 310 is affirmative, the device 104 proceeds to block 315. At block 315, the device 104 is configured to generate assistive data locally, via application of the model 124 to client contextual demand. For example, the device 104-1 can process one or more frames of video data from the camera 116, and/or data captured via a microphone or other input of the input assembly 270, and/or other data such as an identifier of the task being performed by the operator of the device 104-1, with the model 124. The output of the model 124 may be a classification, or set of classifications, of the contextual data that are then used to retrieve assistive data from the repository 120 stored in the memory 254. For example, the output of the model 124 may include an indication of a type, model or the like of equipment on which the operator is working, a component of that equipment that is shown in the video frames, a state of the component (e.g. whether the component is damaged), and the like. Assistive data in the repository 120 can be categorized according to attributes such as equipment type, component type, component state, and the like. Thus, using the output of the model 124, the device 104 can select relevant assistive data from the repository at block 315.

At block 320, having selected assistive data locally, the device 104 is configured to present the assistive data to the operator of the device 104. For example, the processor 250 can control the display(s) 262 to render at least a portion of the assistive data as an overlay on a video feed from the camera 116, such that the overlaid data appears to the operator alongside a view of the operator's surroundings (e.g. including the equipment or component the operator is working on). The processor 250 may also present assistive data by playing audible instructions to the operator via the speaker(s) 226, for example.

When the determination at block 310 is negative, the device 104 proceeds to block 325 rather than to block 315. At block 325, when the model 124 and/or the repository 120 are not available locally, the device 104 is configured to request assistive data from the server 128 rather than generating such assistive data locally. Specifically, the device 104 is configured to send a request to the server 128 at block 325. The request includes the above-mentioned contextual data (e.g. video frames, audio captured via microphone, device location, task identifier and the like). The request also includes a type indicator. The type indicator indicates whether the request is of a first type or a second type. As will be discussed in greater detail below, requests of the first and second types are processed differently from one another at the server 128, as a result of their differing origins at the client devices 104.

The request sent at block 325, in the present example, includes a first type indicator. The type indicator can include a binary flag, a field of metadata associated with the contextual data, or the like. In response to the first request, the server 128 is configured to retrieve assistive data from the repository 120 stored thereon via application of the model 124. The assistive data selected by the server 128 is returned to the client device 104, and at block 330 the client device 104 therefore receives the assistive data via the network 132.

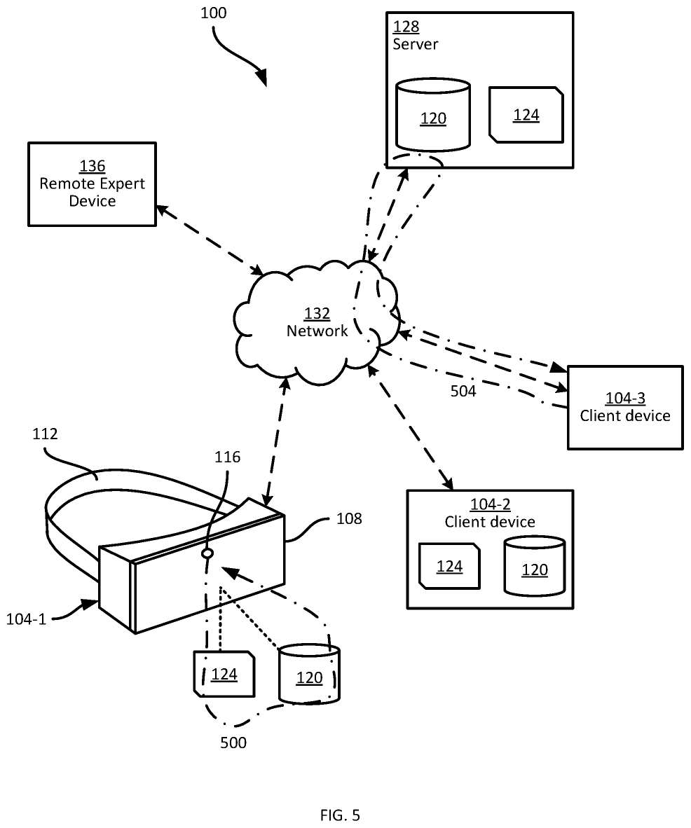

Following receipt of the assistive data at block 330, the device 104 is configured to present the assistive data at block 320, as described above. Referring briefly to FIG. 5, example performances of the portion of the method 300 described above are illustrated within the system 100. In particular, at the device 104-1 the dash-dot line indicates an internal path by which the device 104-1 processes data from the camera 116 to select and present assistive data from the local copy of the repository 120. That is, the device 104-1 performs blocks 305, 310, 315 and 320. A second path 504 indicates that the device 104-3, which lacks the model 124 and repository 120, sends a request of the first type to the server 128, which responds with assistive data from the repository 120 (selected via the server 128 copy of the model 124). That is, the client device 104-3 performs blocks 305, 310, 325, 330 and 320 of the method 300.

Returning to FIG. 3, it will now be apparent that at block 320, the client device 104 presents assistive data selected automatically from the repository 120 (whether a local copy or the server copy of the repository 120). The device 104 proceeds to block 335, at which the device 104 determines whether the assistive data presented at block 335 is acceptable to the operator of the device 104. The determination at block 335 can be based on operator input captured via the input assembly 270. For example, the operator can indicate via spoken command, activation of keypad inputs or the like, whether automatically-selected assistive data presented at block 320 is relevant to the task being performed by the operator.

When the determination at block 335 is affirmative, the performance of the method 300 can terminate, although as discussed later below, the device 104 may receive an updated model 124 and/or repository 120. An affirmative determination at block 335 may result from explicit input from the operator of the device 104 indicating that the assistive data presented at block 320 is sufficient. An affirmative determination at block 335 may also be made when a predefined time period has elapsed without an indication from the operator that the assistive data is not sufficient.

When the determination at block 335 is negative, the device 104 proceeds to block 340. At block 340, the device 104 generates a sends a request to the server 128 with a second type indicator distinct from the first type indicator mentioned earlier in connection with block 325.

The request sent at block 340 can be distinguished from the request at block 325 by its content other than the type indicator. For example, the request sent at block 340 can include not only the contextual data that was employed at block 315 or sent in the request at block 325, but also the assistive data presented at block 320. In other words, the request sent at block 340 indicates that specific assistive data has been presented at the client device 104 in response to specific contextual data, and that the assistive data is unsatisfactory, insufficient, or the like.

Requests having the second type indicator are processed differently by the server 128. In particular, because requests with the second type indicator result from insufficient or less relevant automatically-selected assistive data, the server 128 responds to such requests by requesting manually-selected assistive data from the expert device 136. The resulting assistive data is returned to the client device 104, which receives and presents the assistive data at block 345.

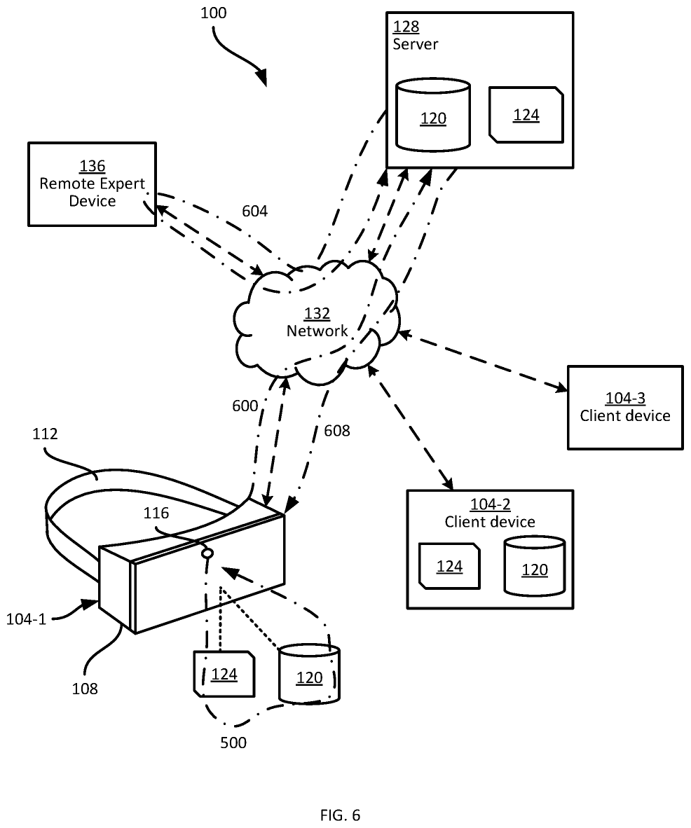

Turning to FIG. 6, an example performance of blocks 335, 340 and 345 by the client device 104-1 is shown, along with activity by the server 128 to be discussed in greater detail below. In particular, the device 104-1, e.g. following an indication that the assistive data presented at block 320 (generated via the path 500 mentioned in connection with FIG. 5) is unsatisfactory. The device 104-1 transmits a request 600 having the second type indicator. Upon receipt of the request 600, the server 128 routes a request 604 to the expert device 136, and receives manual assistive data therefrom. That is, the server 128 does not generate automatic assistive data using the model 124, because the request 600 indicates that automatically generated assistive data was insufficient. The manual assistive data is then returned to the device 104-1 via a message 608.

Receipt of manual assistive data at the server 128, among other events, may also trigger an update to the model 124 and repository 120 at the server 128. Following such an update, the server 128 may deploy the updated model 124 and repository 120 to certain client devices 104 (e.g. the devices 104-1 and 104-3). Such client devices 104 are configured to receive the update model 124 and/or repository at block 350 and store the updated materials in the memory 254 for use in subsequent performances of block 315.

Turning now to FIG. 4, the method 400 will be described in further detail, with reference to the method 300 and the diagrams of FIGS. 5 and 6. In general, the method 400 is performed at the server 128 via execution of the application 212, to respond to requests from client devices 104. The handling of requests at the server 128 varies depending on the type of the requests, as indicated by the above-mentioned type indicators.

At block 405 the server 128 receives a request from a client device 104. The request can be a request generated by the client device 104 via either of blocks 325 and 340 shown in FIG. 3. The server 128 is configured, at block 410, to select between distinct request handling procedures based on the type of the incoming request. When the request received at block 405 is of the first type, as in the case of the request 504 shown in FIG. 5, the server 128 proceeds to block 415.

At block 415, the server 128 generates assistive data automatically by applying the model 124 to the contextual data received with the request from block 405. The generation of assistive data at block 415 is substantially as described above in connection with block 315 of the method 300. The assistive data is returned to the client device 104 at block 420. As will now be apparent, the assistive data returned at block 420 is received by the client device 104 at block 330 of the method 300, for presentation to the operator of the device 104 at block 320.

When the determination at block 410 is that the request is of the second type, however, the server 128 proceeds to block 425. At block 425, the server 128 routes the request to the expert device 136, as shown in FIG. 6 via the request 604. At block 430, the server 128 receives the manually generated assistive data from the expert device 136, and returns the assistive data to the client device 104. As will now be apparent, the manual assistive data is received and presented at the device 104 at block 345.

In addition to returning assistive data to client devices 104, the server 128 can update the model 124 and/or the repository 120 at block 435. In particular, the server 128 may proceed to block 435 following handling of a request of the second type, as such a request indicates that the model 124 may need updating. The server 128 may also update the model 124 in response to a request of the first type, however, for example following a predefined time period since the previous update.

Updating the model at block 435 includes executing a training process based on labelled samples of training data. The labelled samples may each include, for example, a set of client contextual data, a corresponding set of assistive data, and an indication of whether the assistive data is accurately associated with the contextual data. When the assistive data of a sample is accurately associated with the contextual data, the sample is a positive training sample. When the assistive data of a sample is not accurately associated with the contextual data, the sample is a negative training sample.

As will now be apparent, the requests of the second type can constitute negative training samples. In other words, the server 128 may collect training samples through repeated performances of the method 400. For example, second-type requests received at block 405 can be processed as negative training samples, and expert-generated assistive data received at block 430 can be processed as positive training samples. The manual assistive data can also be added to the repository 120.

Following an update to the model 124 and/or repository 120, the server 128 can deploy the updated model 124 and/or repository 120 to one or more client devices 104 at block 440. For example, the server 128 can maintain a list of client devices 104 that have sufficient computational resources to use the model 124, and can therefore transmit the model 124 (and, if new content is included therein, the new content in the repository 120) to those client devices 104. The relevant client devices 104 can receive and store the updated model 124 and/or repository 120 at block 350 of the method 300.

Variations to the above systems and methods are contemplated. For example, in some implementations the client devices 104 can perform a confidence check after block 315. In particular, the output of the model 124 may include a confidence level indicating a likelihood that the automatic assistive data is accurately associated with the client contextual data. When the confidence level is below a predefined threshold, the client device 104 may proceed directly to block 340, without presenting the assistive data at block 320. The server 128 may also implement a similar confidence check following block 415 (but before block 420). For example, the server 128 may generate an internal second request for processing via blocks 425 and 430 when the confidence level associated with assistive data from block 415 is below a threshold.

In further implementations, the client devices 104 can be configured to send a third type of request following an affirmative determination at block 335. The third request type is not a request for assistive data, but rather indicates that automatic assistive data has been generated or received at the client device 104 that can be used as a positive training sample for future updates to the model 124.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a server of generating assistive data, the method comprising:
receiving, at the server from a client device, a request for assistive data, the request including (i) client contextual data, and (ii) a type indicator corresponding to a first request type or a second request type;
selecting between an automated response mechanism, when the type indicator corresponds to the first request type, and a manual response mechanism when the type indicator corresponds to the second request type;
responsive to selecting the automated response mechanism, retrieving automated assistive data from a repository based on the client contextual data; and
returning the automated assistive data to the client device.

2. The method of claim 1, wherein the client contextual data includes audio and video data captured by the client device; and wherein the automated assistive data includes at least one of video overlay and audio instructions.

3. The method of claim 1, wherein retrieving the automated assistive data from the repository includes applying a classification model to the client contextual data.

4. The method of claim 3, further comprising:
responsive to selecting the manual response mechanism, routing the request to an expert computing device;
receiving manual assistive data from the expert computing device; and
returning the manual assistive data to the client device.

5. The method of claim 4, further comprising:
providing the manual assistive data and the client contextual data to a training module as a positive training sample; and
generating an updated classification model using the training module.

6. The method of claim 5, further comprising: deploying the updated classification model to a subset of a plurality of client devices.

7. The method of claim 6, further comprising: storing a list of at least the subset of client devices at the server.

8. The method of claim 3, further comprising:
responsive to returning the automated assistive data to the client device, receiving a further request including a type indicator corresponding to the second request type; and
providing the automated assistive data and the client contextual data to a training mechanism as a negative training sample.

9. A server, comprising:
a memory storing a repository of assistive data;
a communications interface; and
a processor configured to:
receive, from a client device, a request for assistive data, the request including (i) client contextual data, and (ii) a type indicator corresponding to a first request type or a second request type;
select between an automated response mechanism, when the type indicator corresponds to the first request type, and a manual response mechanism when the type indicator corresponds to the second request type;
responsive to selection of the automated response mechanism, retrieve automated assistive data from the repository based on the client contextual data; and
return the automated assistive data to the client device.

10. The server of claim 9, wherein the client contextual data includes audio and video data captured by the client device; and wherein the automated assistive data includes at least one of video overlay and audio instructions.

11. The server of claim 9, wherein the processor is configured, in order to retrieve the automated assistive data from the repository, to apply a classification model to the client contextual data.

12. The server of claim 11, wherein the processor is further configured to:
responsive to selection of the manual response mechanism, route the request to an expert computing device via the communications interface;
receive manual assistive data from the expert computing device; and
return the manual assistive data to the client device.

13. The server of claim 12, wherein the processor is further configured to:
provide the manual assistive data and the client contextual data to a training module as a positive training sample; and
generate an updated classification model using the training module.

14. The server of claim 13, wherein the processor is further configured to: deploy the updated classification model to a subset of a plurality of client devices.

15. The server of claim 14, wherein the memory stores a list of at least the subset of client devices at the server.

16. The server of claim 11, wherein the processor is further configured to:
responsive to returning the automated assistive data to the client device, receive a further request including a type indicator corresponding to the second request type; and
provide the automated assistive data and the client contextual data to a training mechanism as a negative training sample.

17. A system, comprising:
a client computing device configured to transmit a request for assistive data; and
a server, comprising:
a memory storing a repository of assistive data;
a communications interface; and
a processor configured to:
receive, from a client device, a request for assistive data, the request including (i) client contextual data, and (ii) a type indicator corresponding to a first request type or a second request type;
select between an automated response mechanism, when the type indicator corresponds to the first request type, and a manual response mechanism when the type indicator corresponds to the second request type;
responsive to selection of the automated response mechanism, retrieve automated assistive data from the repository based on the client contextual data; and
return the automated assistive data to the client device.

18. The system of claim 17, wherein the client device includes a head-mounted display.

19. The system of claim 18, wherein the head-mounted display includes a camera and a microphone controllable to capture the client contextual data.
